(19) United States
(12) Patent Application Publication
(10) Pub. No.: US 2026/0257510 A1
(43) Pub. Date: Sep. 3, 2026

(54) LATENT INFORMATION ON A TRANSPARENT LAYER ON IDENTITY CARDS

(71) Applicant: IAI industrial systems B.V., Veldhoven (NL)

(72) Inventors: Iris Petronella Maria Van Gessel, Eindhoven (NL); Jurgen Kremer, Breda (NL); Marc Del Pozo Puig, Tilburg (NL)

(21) Appl. No.: 19/474,130

(22) PCT Filed: May 17, 2023
(86) PCT No.: PCT/EP2023/063260

§ 371 Date: Oct. 9, 2025

(51) Int. Cl. B42D 25/382; B42D 25/387; B42D 25/41

(52) U.S. Cl. CPC B42D 25/382; B42D 25/387; B42D 25/41

(57) ABSTRACT

The present disclosure provides an identification card (1), including a base sheet (2) and on top of said base sheet an information layer containing at least one feature made of a first material, which is transparent for white light and which under irradiation with electromagnetic radiation which is not in the visible spectrum is opaque and/or colored and/or emits colored light. The feature is at least laterally embedded in a layer made of a second material, which is transparent for white light and which, is or is not under irradiation with electromagnetic radiation which is not in the visible spectrum opaque and/or colored and/or does or does not emit colored light.

The use of ID cards is growing in importance over the world for use as driving licenses, financial transaction or bank cards, national ID cards, student cards, passports, security clearance cards, etc.

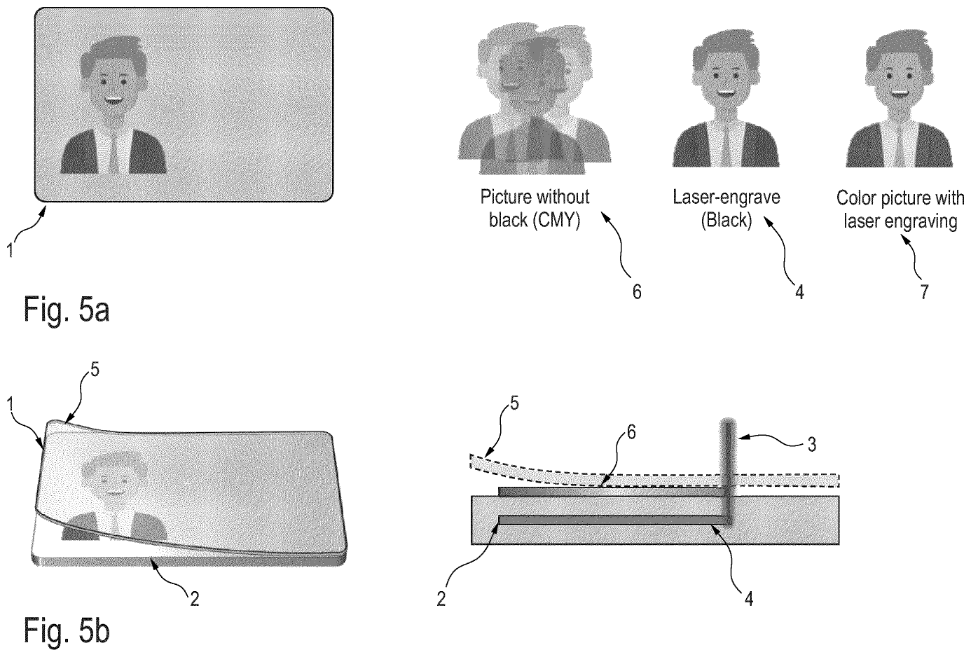

Considering the ease by which some cards can be made, there is a need for high security cards produced with advanced technology. It is important for ID documents to have clear representation of the holder's image that is also protected by layers of additional security levels. A prior art example setting up such an ID card is shown in FIGS. 5a, 5b. This prior art is MB Alfresco® Technology from the company Mühlbauer.

This technology combines color picture personalization with laser engraving. To achieve high security personalization results, the image of the holder is split into two parts by means of an as such known image processing algorithm. The converting process transfers all picture information which describe the details (forensic information) into a greyscale and color image (without picture's black components). During the pre-personalization process, the greyscale information, which contains all picture contrast information, is laser engraved in the polycarbonate cards body inner layer. The picture's remaining color parts are converted to a separate color image and are inkjet printed on the blank document's surface. The final result is a high-resolution color picture, which shows utmost details and has the same long lasting durability characteristic of more than ten years as pure laser engraved images. The high-resolution color pictures only achieved when both the inkjet printed image and the laser engrave image at correctly aligned. Because the color part of the photo is printed on the document surface, to ensure the desired long-lasting durability it has to be additionally protected by an adhesive layer, which is called protection layer or varnish layer.

FIG. 5a shows a prior art example of the complete ID card 1. How the ID card is setup (from different layers), can be derived from FIG. 5b. There is provided a base sheet 2 which in the particular case is made of polycarbonate. Into this polycarbonate layer, there is embedded a greyscale image by laser engraving. The laser beam used for engraving is schematically shown on the right side in FIG. 5b and has reference sign 3. To this greyscale image, which is also shown on the right side of FIG. 5a, there is printed on the top surface layer of the base sheet 2 a color image without the black component 6 of the final picture. Due to superimposing of the color image without black component 6 and the laser engraved greyscale image 4, the final color image 7 is shown on the right side in FIG. 5a. This color image without black component is printed in a so-called inkjet printed layer.

Onto this layer, there is provided a protection layer 5 or varnish layer. This is usually done in the prior art by a liquid coating.

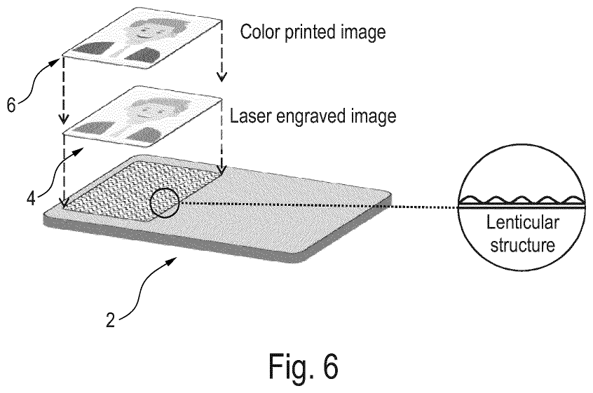

Further to the aforementioned MB Alfresco® Technology, there is known a technology called CLIP-ID from the company Veridos. An example of this technology is shown in FIG. 6. Also in this case, the base sheet 2 is laser engraved with a grey scale image 4.

In the region of the laser engraved image, there is provided a lenticular structure which is added during the lamination process. The roughness of the lenticular lens adds mechanical structure to the layer and enhances durability. On top of this lenticular structure, there is printed a color image not aligned and it is bonded in the regular way as if there would not be a lenticular structure. Thus, the photo is thereby inseparably bonded with the card material.

This makes it easy to detect manipulated ID cards either by touching them or using an infrared light.

In order to provide further features on or in the ID cards, there is also available a further development of the CLIP-ID®, which is known as CLIP-ID ECHO, in which the lenticular lens is used to engrave a certain image at an angle containing variable data from the document holder.

However, such an approach cannot be done for documents missing this lenticular lens, limiting its implementation. In such a solution, placing the variable data is in the same location as the main profile picture would compromise the readability of the image under it.

In view of this, the present invention has been made and it is a goal to add data on top of the top surface without effecting the readability of an image potentially located under it.

Thus, generally, the present invention provides a new security measure for identity cards.

In order to solve the aforementioned problem, there is provided according to claim 1 an information layer which contains at least one feature made of a first material. This feature is at least laterally embedded in a layer of a second material. The first material is transparent for white light and under irradiation with electromagnetic radiation which is not in the visible spectrum, opaque and/or colored and/or emits colored light. The second material is however at least transparent for white light and may or may not be under irradiation with electromagnetic radiation which is not in the visible spectrum opaque and colored and/or may or may not emit colored light.

That means that at least, due to the selection of the first material, when light or another irradiation is used which is not in the visible spectrum, the information defined by the feature will be made visible in the information layer.

As the feature is thus embedded in a second material which preferably is different from the first material, there is at least the area that the feature is embedded in a flat surface which is under irradiation with white light (light in the visible spectrum) transparent and the layer or layers below this information layer is/are visible.

White light is in the present sense light which is set up of a combination of electromagnetic waves of different wavelengths in the visible spectrum, in particular, white light should be understood as light in the visible spectrum and, in particular, composed of different wavelengths so that the optical appearance of the light is white. However, under such white light, the information layer is transparent (in particular transparent for the human eye). So basically, any transparent material can be used.

It may be the case that only the first material under irradiation with electromagnetic radiation which is not in the visible spectrum has a different appearance as the second material. The first material under irradiation with electromagnetic radiation which is not in the visible spectrum is opaque and/or colored and/or emits colored light and the respective second material which embeds the feature, is when it is irradiated with electromagnetic radiation which is not in the visible spectrum transparent.

However, also the second material may be opaque and/or colored and or emits colored light under irradiation with electromagnetic radiation which is not in the visible spectrum.

As long as the material emits colored light, this is also known as fluorescent. Fluorescence de-scribes the spontaneous emission of light in response to excitation by light. Objects that emit fluorescence are called fluorophores. The fluorescence belongs to the photoluminescence, since the excitation takes place by photons. As the material may or may not be colored under the irradiation of electromagnetic radiation which is not in the visible spectrum, any color can be visible under this irradiation such as blue, red, green.

According to the foregoing discussion, when light or another radiation is used, which is not in the visible spectrum, the information provided by the feature or features in the information layer can be made visible.

As electromagnetic radiation which is not visible in the visible spectrum, UV light or IR light or a combination of UV and IR light may be used. That means, under a UV light and/or IR light source, the information contained in the information layer can be made visible. Insofar as in the following it is referred to electromagnetic radiation which is not visible in the visible spectrum, as an example UV light and/or IR light is meant.

According to a further development, the information layer contains one or more or all of the following features, which are inkjet printed in the information layer: texts, letter, picture, number, QR code. This feature or these features is/are embedded in the information layer. So, there may be a combination of any of the aforementioned features. There may be provided different or a plurality of the same letters, different or a plurality of the same words, different or a plurality of the same pictures, or different or a plurality of the same numbers.

In the information layer, there can be also provided a combination of one or more of the same or different letters with one or more of the same or different pictures with one or more of the same or different numbers. One specific feature may be provided in one layer and another feature may be provided in a different layer. The features may also be provided in the same layer.

According to a further development, the information layer may have a first region which is laterally separated from a second region of the information layer. In particular, there may be an (in lateral direction) empty space between the first and second region, wherein no material of the information layer (first and/or second material) is provided. Thus, the first region is laterally separated via a region of the identification card not filled with material from the second region with material from a second region of the information layer. The first and second regions may thus each form flat surfaces which are separated from each other.

The respective first and second region each may include the first and second material and thus are basically flat such that the second material entirely surrounds the first material defining the feature or features, however, between the first and the second region, there may be no material so that the regions of the information layer may protrude from the base sheet of the identification card.

In each of the first and second regions, there may be provided at least one feature. It may also be the case that in first region, there may be a first type of feature and in the second region, there may be a second type of feature. For example, in the first region, there may be a text or letter and in the second region, there may be a number. The respective types of features may or may not be mixed within the first and second regions.

According to a further development, the second material which laterally embeds the first material of the feature may be also provided as a capping layer such that the second materials also covers in the second directions (vertical direction and not only lateral direction) the feature made from the first material.

The capping layer may form in particular smoothly closed surface on the top of the information layer or at least, as long as there is provided a first and second region, which are separated, this capping layer, may be just provided in the first and second region and the capping layer may also be left out in the lateral direction between the first and second regions.

It is not necessary to use for the capping layer the same material which embeds the feature or features. Any material may be used, also a material different from the first and/or second material.

Each layer added increases durability of the layer below, hence adding a capping layer improves durability.

The capping layer prevents that the first material of the feature is lying in the vertical direction free on the outer surface which makes the identification card more durable.

The identification card may or may not have directly on top of an upper surface of the base sheet an inkjet printed layer. The inkjet printed layer may be a CMY photograph or may be any other layer which is inkjet printed. Matching to the area of the inkjet printed layer there can be on top of this inkjet printed layer the information layer, such that there is a stacking of the base sheet, the inkjet printed layer and the information layer. However, the information layer may or may not overlap with the inkjet printed layer, so there may be provided an inkjet printed layer in a different region than the information layer.

The inkjet printed layer may define under white light a monochrome or a CMY color image, in particular the inkjet printed layer may be the aforementioned image with CMY color, which does not have the black component. The black component is provided in the latter and also in the introduction section for the prior art described laser engraved image.

Alternatively or additionally, the inkjet printed layer defines under irradiation with electromagnetic radiation which is not in the visible spectrum, for example UV and/or IR light, a monochrome or CMY color image.

Also in this case, under UV or IR light, this CMY color image may not have the black component which may be provided in the laser engraved image.

The base sheet may or may not contain a laser engraved image within the material of the base layer.

The aforementioned inkjet printed layer and/or the information layer may be directly placed on top in an overlapping relation fully overlapping the respective laser engraved image. Alternatively, the aforementioned layers may not be placed in overlapping relationship, which means, are not over-lapping with the laser engraved image.

The base sheet may contain or may not contain a laser engraved image within the material of the base sheet, wherein the inkjet printed layer and/or the information layer or part thereof or at least the first and second region of the inkjet printed layer or parts thereof is or are placed or is or are not placed in an overlap relationship on top of the laser engraved image.

The aforementioned ID card has at least a base sheet. For the base sheet, any material can be used, however, it is beneficial to use a polymeric material, in particular, it is beneficial to use a thermoplastic or thermosetting material, in particular a polycarbonate material is preferentially used. This base sheet may be made of a single layer or may be made of multiple layers. The information layer may be provided directly on top of this base sheet or via intermediation of one or more further layers.

Also in the present case, there is defined an identification card. The identification card should be interpreted in the broadest sense. Examples for such identification cards are driving licenses, financial transaction or bank cards, national ID cards, student cards, passports, security clearance cards.

It is also not necessary to use for the base sheet a polymeric material. In particular, a paper material, a bamboo based material, a metal material, and/or a recycled material of the paper, metal or a polymeric material can be used.

According to a further development, the information layer or at least the feature or features in the information layer is/are inkjet printed. Thus, the first and or second material may be inkjet printed.

According to a further coordinated aspect of the invention, there is also provided a method for inkjet printing an information layer for generating an identification card.

The method comprises the steps providing a base sheet made of a thermoplastic or thermosetting polymeric material and inkjet printing the information layer or at least one or more features embedded in the information layer. All the aforementioned features in respect to the ID card may also be formulated in a method-related feature for the aforementioned method.

The materials mentioned in the aforementioned sections may be printed from different print heads.

The inks which may be used may be composed by a set of low molecular weight monomers that trigger by a photoiniatiors result in a glassy thermoset polymer network that, when applicable, fixates a pigment within it, which can be UV-fluorescence or IR-upconverter.

However, the aforementioned inks do not delimit the present invention. It is also not necessary to generate the features and the information layer via such an inkjet printing. Any other method may also be used.

However, in the broadest sense, there is provided a certain information in an information layer, which information layer is at least transparent for white light. The invention is in the following explained with different embodiments and the Figures therein:

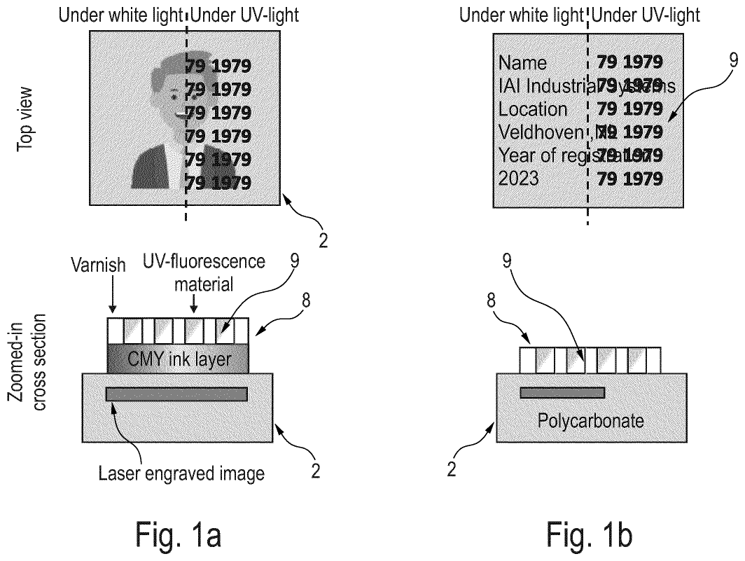

FIGS. 1a and 1b show two variants where an information layer is provided without a capping layer such that the first material defining the feature is directly on top on the top outer surface,

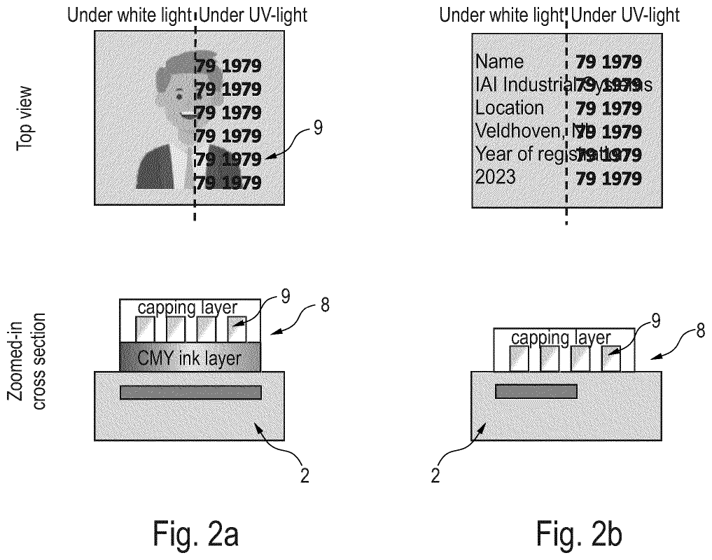

FIGS. 2a and 2b show a variant of the first and second variants of FIGS. 1a and 1b, wherein a further capping layer is provided,

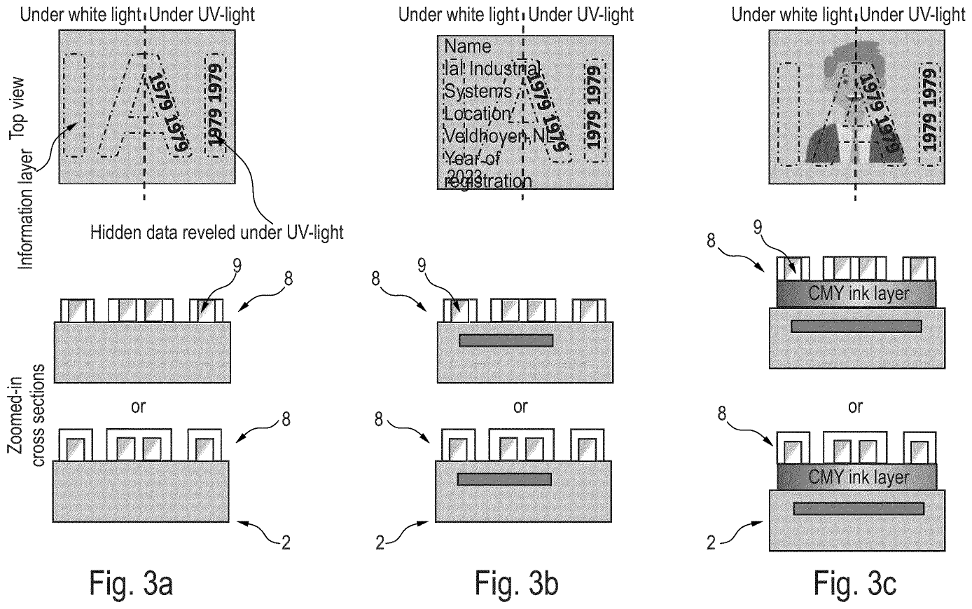

FIGS. 3a to 3c show different variants, wherein the information layer has first, second and third regions which are laterally separated by free spaces not filled with material,

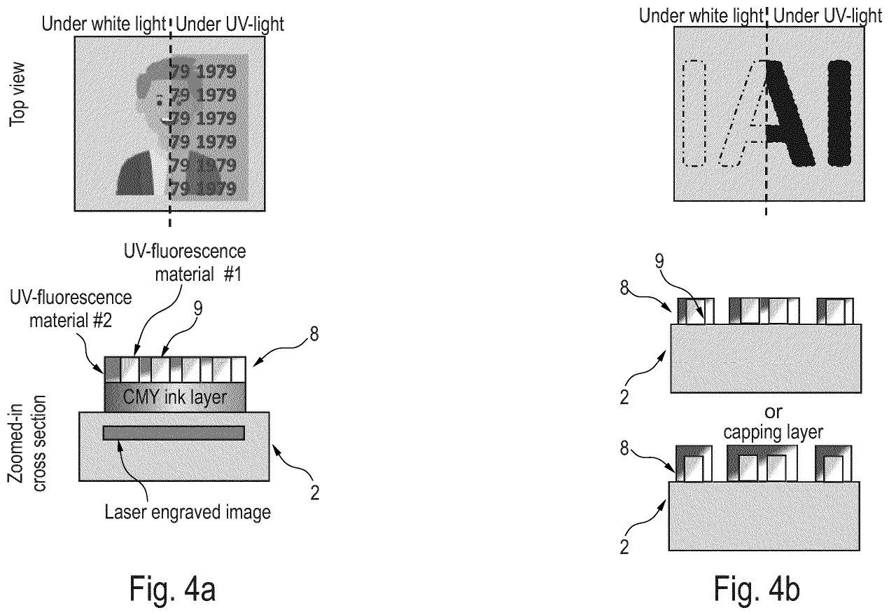

FIGS. 4a and 4b show variants in which not only the first material for the feature is colored under irradiation with UV light but also the second material in which the first material is embedded, is colored in a different color under UV light,

FIGS. 5a and 5b show the prior art MB Alfresco® Technology,

FIG. 6 shows the prior art CLIP-IDTechnology,

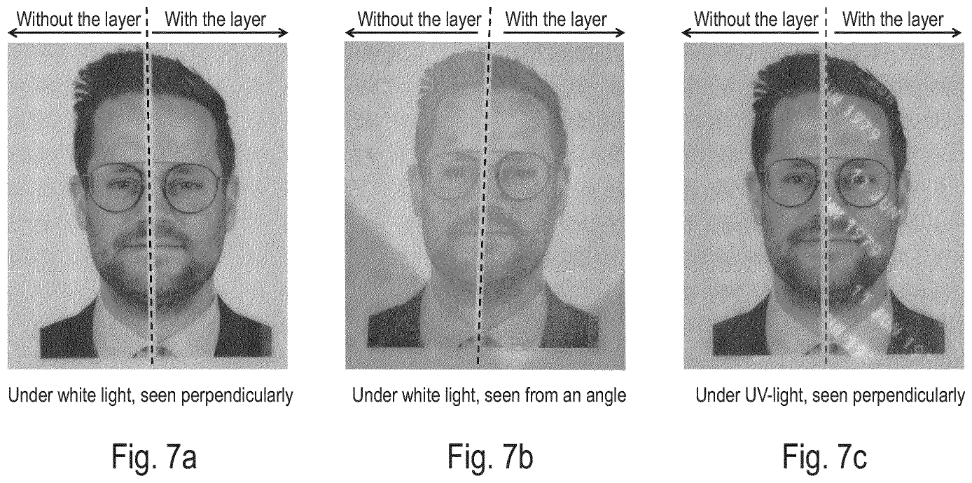

FIG. 7 a, b and c shows a test example under different views or illumination conditions, wherein on top of the printed color image there is provided the information layer which is in the particular case inkjet printed, and

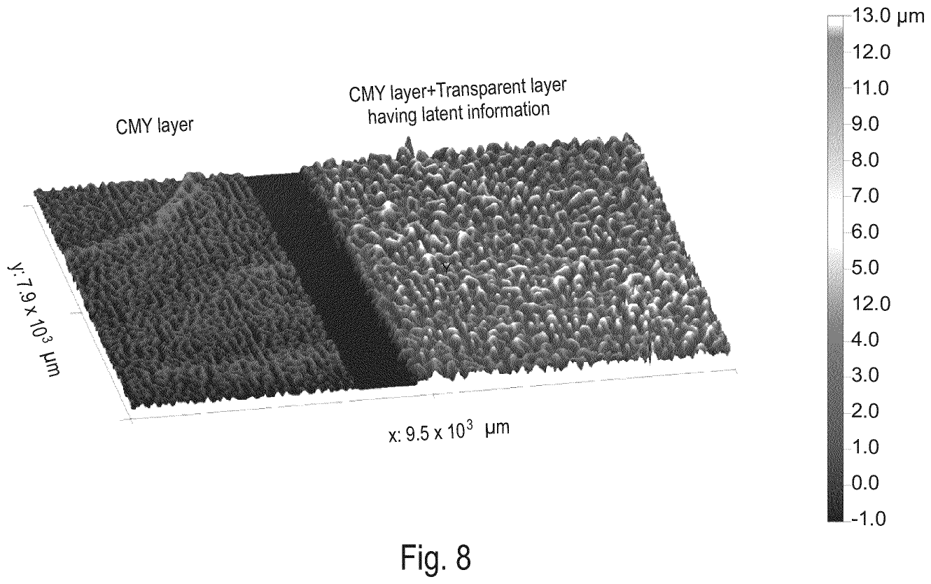

FIG. 8 shows a 3D topography of the information layer having the feature on top of an inkjet printed layer compared to a surface having an inkjet printed layer (CMY layer) thereon.

In FIG. 1a on the upper half, there is shown a top view and on the lower half, there is shown a cross-section of an example material which may defined an ID card 1.

In the present case, there is a base sheet 2. On the top surface of the base sheet 2, there is an inkjet printed layer (identified as CMY layer in the Figures). This layer is a color image without the final picture's black component. Said black component is contained in the laser engraved image. As long as such a laser engraved image is provided in the further embodiment shown in the Figures, it is beneficial that the color image provided in the inkjet printed layer is the image without the final picture's black component.

On top of this inkjet printed layer, there is an information layer 8. The information layer 8 is named information layer, because there is contained information which can be used or seen by a user and/or can be acquired by a scanner or any other information acquisition means. This information layer 8 gives a further security aspect to the ID card.

In the present case, there is provided a feature 9 with a first material, which as seen in the top view of FIG. 1 a, when under irradiation with UV light green reveals the number 1979, however, when under irradiation with white light, this feature 9 is not visible. This feature 9, in particular the number 1979 is embedded within a second material such that the uniform flat information layer 8 is provided. The second material in the present case is transparent both for white light and under UV irradiation.

The UV light shown in the present example is a type of irradiation which is not in the visible spectrum. Presently, under UV light this feature is green, however, the feature may also be opaque and/or has a different color or may also be fluorescent, i.e. such that a specific color is emitted under UV irradiation.

Nevertheless, as derivable from the top view, under white light, the photograph of the person which is composed of the CMY ink layer and the laser engraved image is completely visible.

In the second embodiment shown in FIG. 1b, the respective inkjet printed layer is left out and there is only provided a laser engraved image in the base sheet. The schematic box within the base sheet 2 in FIG. 1b and also the further Figures show the laser engraved image.

However, the configuration of the information layer is the same in the variant in FIG. 1b as in the example in FIG. 1a.

Thus, there is provided the number 1979 which corresponds to the feature 9 which is embedded into a second material which is transparent under white light and under UV light.

The third variant shown in FIG. 2a is a further development of the first embodiment, wherein the second material in which the feature is embedded is now also used in a capping layer such that the respective features are laterally and in the stacking direction on top completely surrounded by the second material. Also in this case, the second material is transparent under white light and under UV light. The fourth variant in FIG. 2b corresponds to the third variant in FIG. 2a, wherein the inkjet printed layer is left out or put in another way, is based on the second variant of FIG. 1b, wherein additionally the capping layer is provided.

In the variants in FIGS. 3a to 3c, the respective information layer is not completely closed and uniform at the surface, but there are provided different regions which are separated and laterally spaced from each other by a region where no material is provided.

In FIG. 3a, there are provided two variants. On top, there is shown again the top view, while the two lower parts of FIG. 3a relate to cross-sections for the two different variants.

In this case of the variant of FIG. 3a, there are provided three regions of information layers. The appearance of the first region corresponds to an “I”, the appearance of the second region to an “A”, the appearance of a third region to an “I”.

However, in each region, the respective features, in particular the number, are printed.

The difference between the variant in FIG. 3a in the middle and the variant at the bottom is that in the middle, there is no capping layer while at the bottom variant, there is a capping layer.

Nevertheless, the basic configuration is the same as for the aforementioned embodiments. The second material is transparent under white light and under UV light, wherein the first material for the feature has a green color under UV radiation.

In the case of FIG. 3a, there is no laser engraved image below within the base sheet.

The two variants in FIG. 3b correspond to the variants in FIG. 3a, wherein below, at least a part of the first and a part of the second and/or third region, there is provided the laser engraved image within the base sheet. This laser engraved image is thus visible as shown in the top view in FIG. 3b.

In the variant in FIG. 3c, additionally to the laser engraved image of FIG. 3b, there is provided between the information layer and the base sheet the inkjet printed layer. In the present case it is and CMY inkjet printed layer such that the photograph can be seen.

In the further variants in FIGS. 4a and 4b, there is shown a situation, wherein the second material, in which the first material defining the feature is embedded, also has a colored appearance under UV light. The color of the second material is different from the color of the feature.

In FIG. 4a, this configuration basically corresponds to the configuration of the first variant in FIG. 1a, wherein here, the second material is also colored under UV light.

The variants shown in FIG. 4b correspond to the two variants shown in FIG. 3a, wherein also here, the second material is also colored under UV light.

In the present case, the materials may be inkjet printed in the information layer, i.e. two materials may be provided from print heads to provide this layer.

In FIG. 7 a to c, there is shown on the respective right part of the figure (“with layer”) a test example of a variant corresponding to the variant shown in FIG. 1a. This is compared to a variant on the respective left part of the figure, where no such information layer is provided. FIG. 7a shows a situation when viewed perpendicular under white light. There is no feature visible in the information layer. FIG. 7b shows a situation when viewed from an angle under white light. There is no feature visible in the information layer. FIG. 7c shows a situation when viewed perpendicular under UV-light. There is as feature the number 1979 visible in the information layer.

FIG. 8 shows on the right part thereof a 3D topography of the information layer having the feature on top of an inkjet printed layer compared to a surface having an inkjet printed layer (CMY layer) thereon, which is shown on the left side of said image. So the roughness of the surface of the information layer may be in the range of maximum 1.5+/−0.2 μm or lower. However, the surface of the information layer is comparable smooth and/or closed. In the present example the thickness of the information layer is 4±2 μm. Furthermore, the thickness of the information layer plus the CMY layer underneath it is 6±2 μm.

Also in the previous section, there is described the specific material which is transparent in the visible spectrum and which may have a color under UV light, this color is not delimited to a specific color shown. There may also be an opaque appearance or this material may reflect a color, however, these irradiations are also not delimited to irradiation with UV light but can be under IR light or any other radiation not in the visible spectrum.

### LIST OF REFERENCE SIGNS

1 ID-card
2 base sheet
3 laser beam
4 greyscale image
5 protection layer
6 color image without black component
7 final image
8 information layer
9 feature

1. An identification card comprising a base sheet and, on top of the base sheet, an information layer containing at least one feature made of a first material that is transparent for white light and, under irradiation with electromagnetic radiation that is not in the visible spectrum, is at least one of opaque, colored, or emits colored light;
wherein the at least one feature is at least laterally embedded in a layer made of a second material that is transparent for white light.

2. The identification card according to claim 1, wherein the electromagnetic radiation is UV-light or IR-light.

3. The identification card according to claim 1, wherein the at least one feature comprises at least one of a text, letter, picture, number, or QR code.

4. The identification card according to claim 1, wherein the information layer has a first region, which is laterally separated, via a region of the identification card not filled with material, from a second region of the information layer.

5. The identification card according to claim 4, wherein in each of the first and second regions there is provided the at least one feature.

6. The identification card according to claim 1, wherein the second material is also provided in a capping layer such that the second material encloses the first material completely in the lateral direction and in a stacking direction, wherein the capping layer forms a smooth closed surface layer on top of the information layer or the first regions of the information layer.

7. The identification card according to claim 1, further comprising an inkjet printed layer directly on top of an upper surface of the base sheet.

8. The identification card according to claim 7, wherein the inkjet printed layer defines, under at least one of white light or irradiation with the electromagnetic radiation, a monochrome or CMY-color image.

9. The identification card according to claim 1, wherein the base sheet contains a laser engraved image.

10. The identification card according to claim 1, wherein the base sheet comprises a thermoplastic or thermosetting polymeric material.

11. The identification card according to claim 1, at least the at least one feature is ink jet printed.

12. The identification card according to claim 1, wherein, under irradiation with the electromagnetic radiation, the second material is at least one of opaque, colored, or emits colored light.

13. The identification card according to claim 1, wherein, under irradiation with the electromagnetic radiation, the second material is not opaque or colored, and does not emit colored light.

14. The identification card according to claim 4, wherein the second material is also provided in a capping layer such that the second material encloses the first material completely in the lateral direction and in a stacking direction, wherein the capping layer forms a smooth closed surface layer on top of the first and second regions of the information layer.

15. The identification card according to claim 7, wherein the information layer or a part thereof is placed in an overlapping relationship on top the inkjet printed layer.

16. The identification card according to claim 4, wherein the identification card further comprises an inkjet printed layer directly on top of an upper surface of the base sheet, wherein the first and second regions or parts thereof are placed in an overlapping relationship on top the inkjet printed layer.

17. The identification card according to claim 7, wherein the base sheet contains a laser engraved image, and wherein at least a part of at least one of the inkjet printed layer or the information layer is placed in an overlapping relationship on top of the laser engraved image.
